(19) United States
(12) Patent Application Publication
(10) Pub. No.: US 2024/0255615 A1
(43) Pub. Date: Aug. 1, 2024

(54) METHOD AND SYSTEM FOR DETECTING BUSH

(71) Applicants: HYUNDAI MOTOR COMPANY, Seoul (KR); KIA CORPORATION, Seoul (KR)

(72) Inventor: Woo Cheol Choi, Incheon (KR)

(73) Assignees: HYUNDAI MOTOR COMPANY, Seoul (KR); KIA CORPORATION, Seoul (KR)

(21) Appl. No.: 18/520,893

(22) Filed: Nov. 28, 2023

(30) Foreign Application Priority Data
Jan. 27, 2023 (KR) 10-2023-0010995

(51) Int. Cl. G01S 7/48; G01S 17/931

(52) U.S. Cl. CPC G01S 7/4802; G01S 17/931

(57) ABSTRACT

A bushes detection method includes: based on an echo pulse width (EPW) value of point data of each object, determining an object having feature point data corresponding to a bush feature as a candidate bush object; generating a grid map based on point data of the candidate bush object; and based on point data that matches a cell including point data of the grid map, of point data of an object of interest (OOI) determined for an association, determining the OOI as bushes and outputting related information.

### CROSS-REFERENCE TO RELATED APPLICATION

The present application claims priority to Korean Patent Application No. 10-2023-0010995, filed on Jan. 27, 2023, the entire contents of which is incorporated herein for all purposes by this reference.

### BACKGROUND OF THE PRESENT DISCLOSURE

### Field of the Present Disclosure

The present disclosure relates to a method and system for detecting bush.

### Description of Related Art

A typical method of determining whether an object is in a moving and/or stationary state based on light detection and ranging (LiDAR) point data has been performed based on object shape and classification information, road boundary information, and/or internal grid map information.

For all objects located around a vehicle, when determining whether they are moving or stationary objects, an object such as a low flower bed and a newly growing bush with a large computational load and being in an area in a field of view (FOV) is highly likely to be misrecognized by an internal weight of a vehicle system for responding to a cut-in vehicle.

Typically, when a sensor fusion system of a vehicle performs an association for object tracking based on LiDAR point data, there may be many limiting situations in which an association error occurs due to false detection of an object, such as cases in which a street tree and a vehicle passing under the street tree are determined as one object, or bushes and a guardrail with thick bushes are determined as one object.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing bushes detection method and system for solving an issue of misrecognizing moving objects by objects such as flower beds, bushes, and/or street trees, and improving association logic for object tracking.

For example, the bush detection method and system may provide a technique for determining whether an object is bushes using an echo pulse width (EPW) of LiDAR point data of an object and for representing an area corresponding to bushes as a grid.

According to an aspect of the present disclosure, there is provided bushes detection method including determining, as a candidate bush object, an object including feature point data corresponding to a bush feature based on echo pulse width (EPW) values of point data of each object, generating a grid map based on point data of the candidate bush object, and based on point data, among point data of an object of interest (OOI) determined for an association, that matches a cell encompassing point data of the grid map, determining the OOI as bushes and outputting related information.

In at least an exemplary embodiment of the present disclosure, determining the object including the feature point data as the candidate bush object includes determining, as the feature point data, point data including EPW values greater than or equal to a predetermined reference EPW value among the point data of each object, and storing the feature point data in a feature point array of a corresponding object.

In at least an exemplary embodiment of the present disclosure, the point data of each object is located within a predetermined distance from a vehicle.

In at least an exemplary embodiment of the present disclosure, determining the object including the feature point data as the candidate bush object is performed based on at least one of a ratio of a number of the feature point data to the total number of point data of the object including the feature point data, a length of a longest side of an object box of the object including the feature point data, a variance of each of the feature point data with respect to a mean position of the object including the feature point data, or a covariance of feature points of the objects including the feature point data.

In at least an exemplary embodiment of the present disclosure, the method may further include converting candidate bush point data of a previous time step frame of the candidate bush object into candidate bush point data based on a current time step frame by compensating for a movement amount for each frame based on a movement amount of a vehicle at acquisition of each frame of the candidate bush object, wherein the point data of the candidate bush object includes the converted candidate bush point data obtained by the converting.

In at least an exemplary embodiment of the present disclosure, the method further includes storing, in a buffer including a predetermined size, the candidate bush point data for each frame and movement amount information of the vehicle at acquisition of a corresponding frame.

In at least an exemplary embodiment of the present disclosure, generating the grid map includes based on converting the converted candidate bush point data into an index of the grid map, assigning a bush grid flag and matching height information comprised in a corresponding index, to a cell of the grid map matching the converted candidate bush point data.

In at least an exemplary embodiment of the present disclosure, when two or more point data of the converted candidate bush point data match one cell of the grid map, the height information stored in the one cell is information of a minimum height in height information of the two or more point data.

In at least an exemplary embodiment of the present disclosure, the method further includes determining a movable path of the vehicle on the grid map, identifying cells to which the bush grid flag is assigned, which are closest on left and right sides with respect to Y-axis coordinate values corresponding to the movable path, in the grid map, assigning a drivable flag to cells including height information greater than or equal to predetermined reference height among the identified cells; and assigning a non-drivable flag to cells including height information lower than the predetermined reference height among the identified cells.

In at least an exemplary embodiment of the present disclosure, determining the OOI as bushes includes when at least one of the point data of the OOI matches a cell of the grid map to which the bush grid flag is assigned, and at least one of the point data of the OOI matches a cell of the grid map to which the drivable flag is assigned, determining the OOI as bushes.

In at least an exemplary embodiment of the present disclosure, the method further includes determining a score based on a ratio of a number of feature point data to a total number of point data of the object including the feature point data, a variance of each of the feature point data with respect to a mean position of the object including the feature point data, a covariance of feature points of the object including the feature point data, and the EPW values of the feature point data, and assigning a confidence level to the OOI determined as bushes, based on the determined score.

In at least an exemplary embodiment of the present disclosure, the OOI determined as bushes is excluded from an OOI for the association.

According to another aspect of the present disclosure, there is provided a bush detection system including an interface configured to receive, from a Light Detection and Ranging (LiDAR), point data of each object and echo pulse width (EPW) values of the point data of each object, and a processor communicatively or electrically connected to the interface, wherein the processor is configured to based on the EPW values of the point data of each object, determine an object including feature point data corresponding to a bush feature as a candidate bush object, generate a grid map based on point data of the candidate bush object, and based on point data, among point data of an object of interest (OOI) determined for an association, that matches a cell encompassing point data of the grid map, determine the OOI as bushes and output related information.

In at least one embodied system of the present disclosure, the processor is further configured to determine, as the feature point data, point data including EPW values greater than or equal to a predetermined reference EPW value of the point data of each object, and store the feature point data in a feature point array of a corresponding object.

In at least one embodied system of the present disclosure, the processor is further configured to determine the object including the feature point data as the candidate bush object, based on at least one of a ratio of a number of feature point data to a total number of point data of the object including the feature point data, a length of a longest side of an object box of the object including the feature point data, a variance of each of the feature point data with respect to a mean position of the object including the feature point data, or a covariance of feature points of the object including the feature point data.

In at least one embodied system of the present disclosure, the processor is further configured to convert candidate bush point data of a previous time step frame of the candidate bush object into candidate bush point data based on a current time step frame by compensating for a movement amount for each frame based on a movement amount of a vehicle at acquisition of each frame of the candidate bush object, wherein the point data of the candidate bush object includes the converted candidate bush point data obtained by the converting.

In at least one embodied system of the present disclosure, the processor is configured to based on converting the converted candidate bush point data into an index of the grid map, assign a bush grid flag and match height information comprised in a corresponding index, to a cell of the grid map matching the converted candidate bush point data.

In at least one embodied system of the present disclosure, when two or more point data of the converted candidate bush point data match one cell of the grid map, the height information stored in the one cell is information of a minimum height in height information of the two or more point data.

In at least one embodied system of the present disclosure, the processor is configured to determine a movable path of the vehicle on the grid map, identify cells to which the bush grid flag is assigned, which are closest on left and right sides with respect to Y-axis coordinate values corresponding to the movable path, in the grid map, assign a drivable flag to cells including height information greater than or equal to predetermined reference height among the identified cells; and assign a non-drivable flag to cells including height information lower than the predetermined reference height among the identified cells.

In at least one embodied system of the present disclosure, the processor is further configured to when at least one of the point data of the OOI matches a cell of the grid map to which the bush grid flag is assigned, and at least one of the point data of the OOI matches a cell of the grid map to which the drivable flag is assigned, determine the OOI as bushes.

According to an exemplary embodiment of the present disclosure, bush detection method and system may solve an issue of misrecognizing an object, for example, a moving object, by an object such as a flower bed, bushes, and/or a street tree.

Accordingly, the bush detection method and system may improve an association logic for object tracking, improving the accuracy of driving control (also referred to as autonomous driving) of a vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a vehicle according to an exemplary embodiment of the present disclosure.

FIG. 2 is a flowchart illustrating operations of a bush detection system according to an exemplary embodiment of the present disclosure.

FIG. 3A and FIG. 3B are flowcharts illustrating operations of a bush detection system according to an exemplary embodiment of the present disclosure.

FIG. 4A, FIG. 4B, FIG. 4C and FIG. 4D, FIG. 5, FIG. 6, FIG. 7, FIG. 8, FIG. 9A and FIG. 9B, FIG. 10, FIG. 11A and FIG. 11B, and FIG. 12 illustrate operations of a bush detection system according to an exemplary embodiment of the present disclosure.

FIG. 13A, FIG. 13B and FIG. 13C, FIG. 14A, FIG. 14B and FIG. 14C and FIGS. 15A-15C illustrate the effects of embodiments of the present disclosure by comparing object information obtained according to the related art and the exemplary embodiments of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The terms “module,” “unit,” and/or “-er/or” for referring to elements are assigned and used interchangeably in consideration of the convenience of description, and thus the terms per se do not necessarily have different meanings or functions. The terms “module,” “unit,” and/or “-er/or” do not necessarily require physical separation. For example, “OO module, unit, and/or -er/or” and “XX module, unit, and/or -er/or” may be components that perform different functions, but may not be physically separated but may perform the functions in parallel or in sequential order in the same microprocessor.

When an element is described as being “coupled” or “connected” to another element, the element may be directly coupled or connected to the other element. However, it is to be understood that another element may be present therebetween. In contrast, when an element is referred to as being “directly coupled” or “directly connected” to another element, it should be understood that there are no other elements therebetween.

It will be further understood that the terms “includes/including” and/or “includes/including” used herein specify the presence of stated features, integers, steps, operations, elements, and/or components, but do not preclude the presence or addition of one or more other features, integers, steps, operations, elements, components and/or groups thereof.

Although terms including ordinal numbers, such as “first,” “second,” and the like, may be used herein to describe various elements, the elements are not limited by these terms. These terms are only used to distinguish one element from another.

The singular forms “a,” “an,” and “the” are intended to include the plural forms as well, unless the context clearly indicates otherwise.

The identification numbers, or reference numerals, assigned to respective steps or operations are not provided to describe the order or sequence of the steps or operations, and the steps or operations may be performed in different orders unless the context clearly indicates otherwise.

The present disclosure relates to a technology for improving an association logic in moving and/or stationary object misrecognition and object tracking, for a vehicle (also referred to as an “autonomous vehicle”) traveling on a road.

The present disclosure relates to a technology for determining in real time whether an object is bushes without a separate deep learning technology, based on point cloud data of each object, and generating and outputting information by converting bushes area into a grid-based map when the object is determined to be bushes.

Hereinafter, the operating principles and embodiments of the present disclosure will be described with reference to the accompanying drawings.

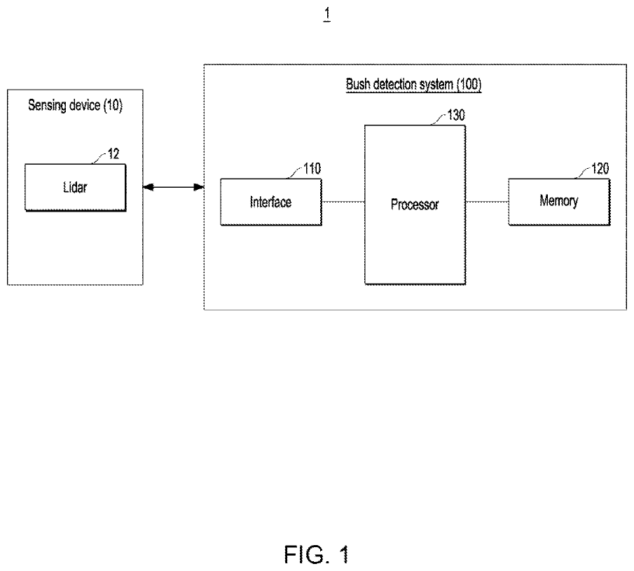

FIG. 1 is a block diagram illustrating a vehicle according to an exemplary embodiment of the present disclosure.

Referring to FIG. 1, a vehicle 1 may include a sensing device 10 and/or a bush detection system 100.

The sensing device 10 may include one or more devices configured to obtain information related to objects (also referred to as “targets”) present around the vehicle 1.

The sensing device 10 may obtain vehicle dynamics input signal processing (VDISP) data of the vehicle 1, which is data used to determine dynamics information (e.g., a speed and yaw rate of the vehicle 1) of the vehicle 1.

The sensing device 10 may include a LiDAR 12, which is a light detection and ranging sensor or system.

The LiDAR 12 may be provided as a single LiDAR or a plurality of LiDARs and may be provided in the vehicle 1 to emit a laser pulse toward the surroundings of the vehicle 1 and generate LiDAR data, i.e., a plurality of point data (or point cloud data).

The LiDAR 12 may also obtain echo pulse width (EPW) (also referred to as the width of a received reflection signal) information based on the emitted laser pulse. For example, the EPW information may be EPW values output as one between 0 or more and 255 or less.

Although not shown, the sensing device 10 may further include a radio detection and ranging (RADAR) configured to detect objects around the vehicle 1 and/or a camera configured to obtain image data around the vehicle 1.

The bush detection system 100 may include an interface 110, a memory 120, and/or a processor 130.

The interface 110 may transmit commands or data input from other devices (e.g., the sensing device 10 and/or a vehicle control device 1000) of the vehicle 1 or a user to other components of the bush detection system 100, or output commands or data received from other components of the bush detection system 100 to other devices of the vehicle 1.

The interface 110 may include a communication module to communicate with other devices of the vehicle 1.

The communication module may include, for example, a communication module configured to perform communication, for example, Controller Area Network (CAN) communication and/or Local Interconnect Network (LIN) communication, between devices of the vehicle 1 over a vehicle communication network. Furthermore, the communication module may include a wired communication module (e.g., a power line communication module) and/or a wireless communication module (e.g., a cellular communication module, a Wi-Fi communication module, a short-range wireless communication module, and/or a global navigation satellite system (GNSS) communication module).

The memory 120 may store various data used by at least one component of the bush detection system 100, for example, input data and/or output data for a software program and commands related thereto.

The memory 120 may include a non-volatile memory such as cache, read-only memory (ROM), programmable ROM (PROM), erasable programmable ROM (EPROM), electrically erasable programmable ROM (EEPROM), and/or flash memory, and/or a volatile memory such as random-access memory (RAM).

The processor 130 (also referred to as “control circuitry” or “controller”) may be configured for controlling at least one other component (e.g., a hardware component (e.g., the interface 110 and/or the memory 120) and/or a software component (e.g., a software program)) of the bush detection system 100 and may perform various data processing and computations.

The processor 130 may determine, as a class which is “bush,” an object such as a street tree, a flower bed, and/or a thicket among objects detected based on point data obtained from the LiDAR 12. The processor 130 may also generate a grid map for bushes area based on an accumulation result for each of obtained frames. The processor 130 may also add a separate flag to an object corresponding to bushes among objects of interest (OOIs) determined for object tracking, i.e., association, to distinguish the bush from other objects.

The processor 130 may be configured to determine an object including feature point data corresponding to a bush feature as a candidate bush object, based on EPW values of point data of each object.

For example, the processor 130 may determine, as the feature point data, point data including EPW values greater than or equal to a predetermined reference EPW value among the point data of each object located within a predetermined distance from the vehicle 1, and store the feature point data in a feature point array of a corresponding object.

For example, the processor 130 may be configured to determine the candidate bush object based on the feature point data stored in the feature point array of a corresponding object.

The processor 130 may be configured to generate a grid map based on point data of the candidate bush object.

For example, the processor 130 may compensate for a movement amount of each frame based on a movement amount of the vehicle 1 at the acquisition of each frame of the candidate bush object, and may then convert candidate bush point data of a frame of a previous time step of the candidate bush object into candidate bush point data which is based on a current time step. The processor 130 may be configured to generate the grid map based on the converted candidate bush point data.

Furthermore, the processor 130 may convert the converted candidate bush point data into an index of the grid map, and based on this, may assign a bush grid flag to a cell of the grid map that matches the converted candidate bush point data and may match thereto height information included in a corresponding index.

For example, when two or more converted candidate bush point data among the converted candidate bush point data match one cell of the grid map, height information stored in the one cell may be minimum height information among height information of the two or more converted candidate bush point data.

The processor 130 may be configured to determine a movable path of the vehicle 1 on the grid map. The processor 130 may identify cells to which the bush grid flag is assigned, which are the closest on the left and right sides based on Y-axis coordinate values corresponding to the movable path, on the grid map. The processor 130 may assign a drivable flag to cells including height information greater than or equal to predetermined reference height among the identified cells, and assign a non-drivable flag to cells including height information lower than the predetermined reference height among the identified cells.

The processor 130 may be configured to determine an OOI as bushes based on point data matching a cell including point data of the grid map among point data of an OOI determined for an association, and output related information.

For example, when at least one of point data of an OOI matches a cell of the grid map to which the bush grid flag is assigned and at least one of the point data of the OOI matches a cell of the grid map to which the drivable flag is assigned, the processor 130 may be configured to determine the OOI as bushes.

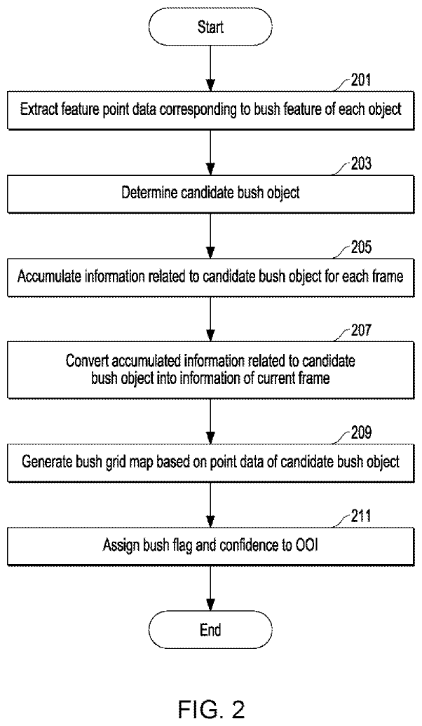

FIG. 2 is a flowchart illustrating operations of the bush detection system 100 (and/or the processor 130) according to an exemplary embodiment of the present disclosure.

Referring to FIG. 2, in operation 201, the bush detection system 100 may extract feature point data corresponding to a bush feature from point cloud data of each object.

The bush detection system 100 may identify point data including EPW values greater than or equal to a predetermined reference EPW value from among point data of objects within a predetermined distance, and may be configured to determine the identified point data as the feature point data corresponding to the bush feature.

In operation 203, the bush detection system 100 may be configured to determine a candidate bush object from among the objects including the feature point data corresponding to the bush feature.

The bush detection system 100 may be configured to determine the candidate bush object from among the objects including the feature point data, based on an x-y covariance of the feature point data among the point data of the objects including the feature point data, a distance variance for each point data of the objects including the feature point data, a longitudinal and/or lateral direction sizes of an object box of an object including the feature point data, and/or a point data ratio greater than or equal to the predetermined EPW values.

In operation 205, the bush detection system 100 may accumulate information related to the candidate bush object for each frame.

Each frame may include point data obtained through the LiDAR 12 for each time step.

Bushes does not move, and thus the bush detection system 100 may be configured to predict a position of bushes in a current frame through data of a previous frame, based on the compensation for a movement amount of the vehicle 1.

That is, in the case of bushes that has not a movement amount, unlike objects such as a vehicle and/or pedestrian each including a separate movement amount, the bush detection system 100 may apply previous data to current data based on the compensation performed based on the movement amount of the vehicle 1.

In operation 207, the bush detection system 100 may convert the accumulated information related to the candidate bush object into current frame information.

For example, the current frame information may include point data of the candidate bush object in a current frame of a current time step.

Through the operations described above, the bush detection system 100 may be configured to determine a movement compensation amount of the vehicle 1 and compensate for a position of the point data of the candidate bush object in the current frame.

In operation 209, the bush detection system 100 may be configured to generate a grid map based on the point data of the candidate bush object, which is also referred to as a bush grid map.

In operation 211, the bush detection system 100 may assign a bush flag and a confidence level to an OOI determined for object tracking.

The OOI determined for object tracking may be an object for an association in a sensor fusion system of the vehicle 1. To determine an object for the association, a typical sensor fusion technique may be applied.

The bush detection system 100 may identify point data included in box data representing an OOI.

To determine whether the point data included in the box data representing an OOI is in the same cell as the point data of the bush grid map, the bush detection system 100 may convert each point data included in the box data representing an OOI into an index of the grid map.

The bush detection system 100 may output information obtained by determining whether the OOI is bushes or not and a confidence level of the determined information, based on the converted index and the matching cell of the bush grid map.

For example, the confidence level may be determined based on the information obtained by determining whether an OOI is bushes. Furthermore, the confidence level may be determined based on a score which is determined based on a ratio (“Rate (EPW)”) of the number of feature point data (“high EPW point num”) to the total number of point data of objects including the feature point data (“Obj total point num”), a length (“box size”) of the longest side of an object box of an object including the feature point data, a variance of distance values of feature points compared to a mean value of point data of the objects including the feature point data, and an x-y covariance.

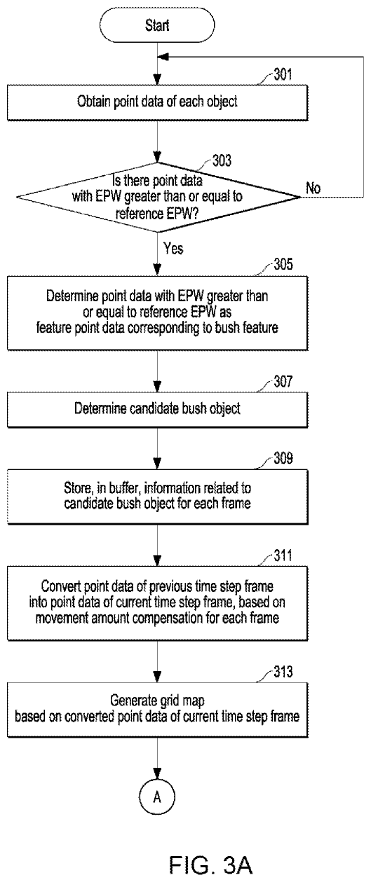

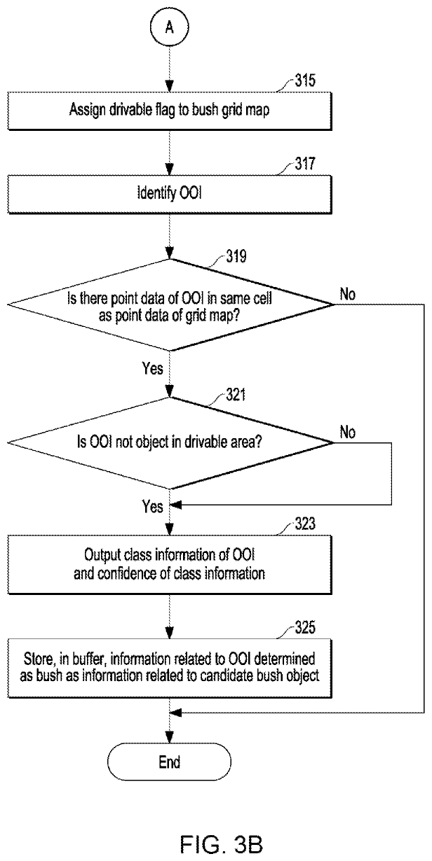

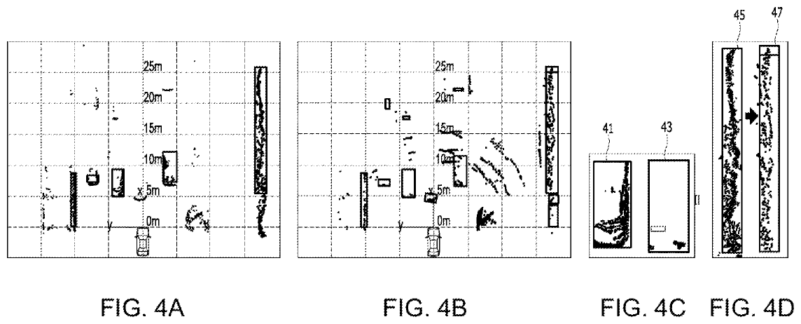

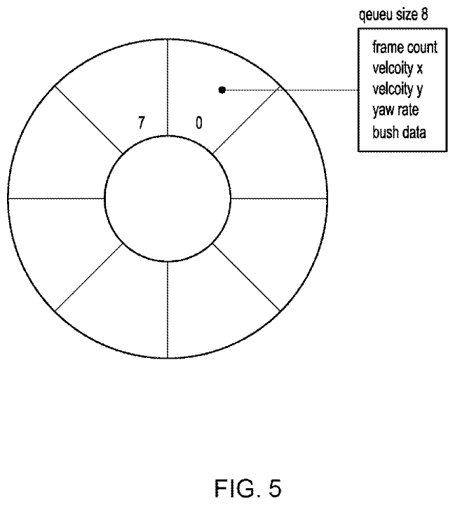

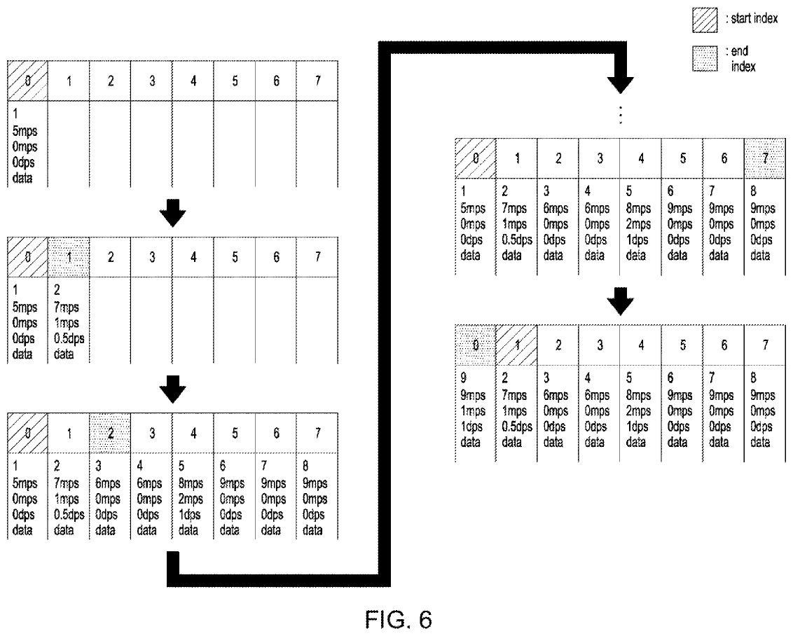

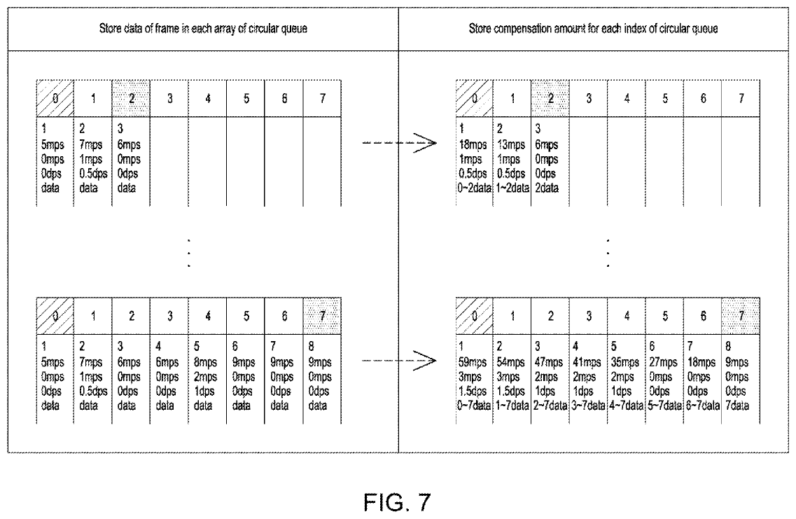

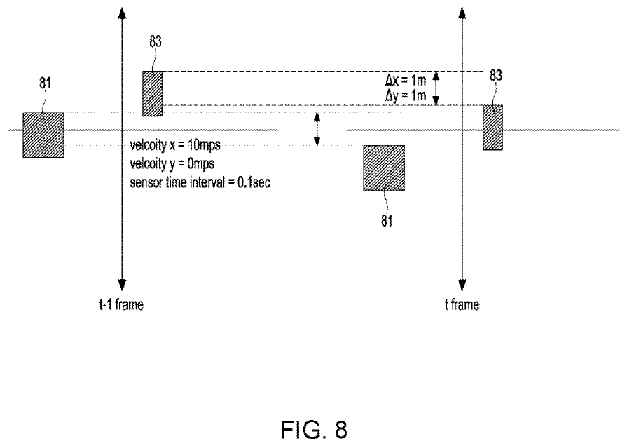

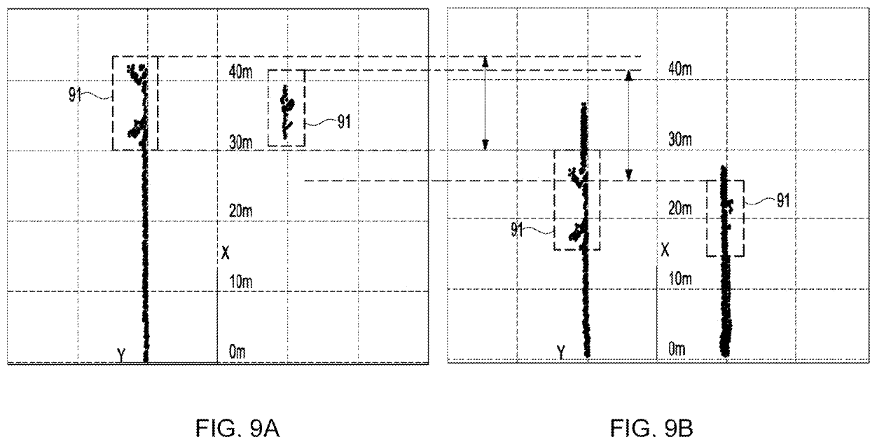

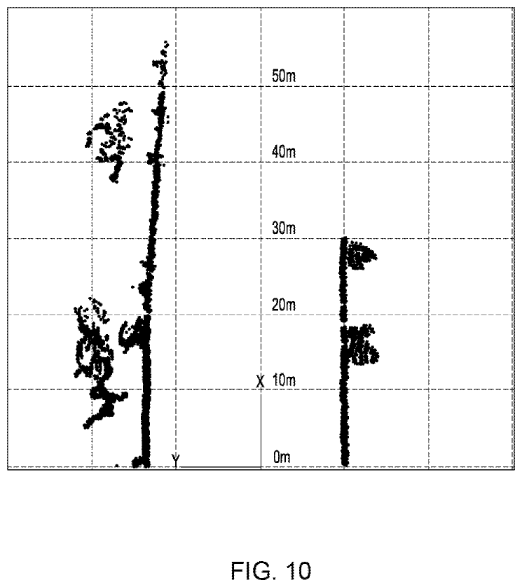

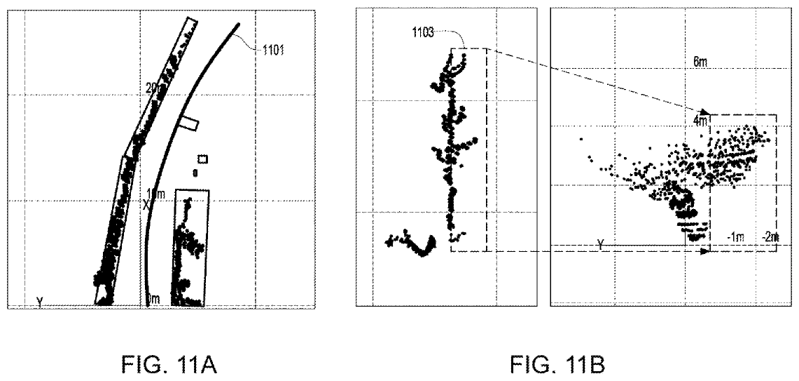

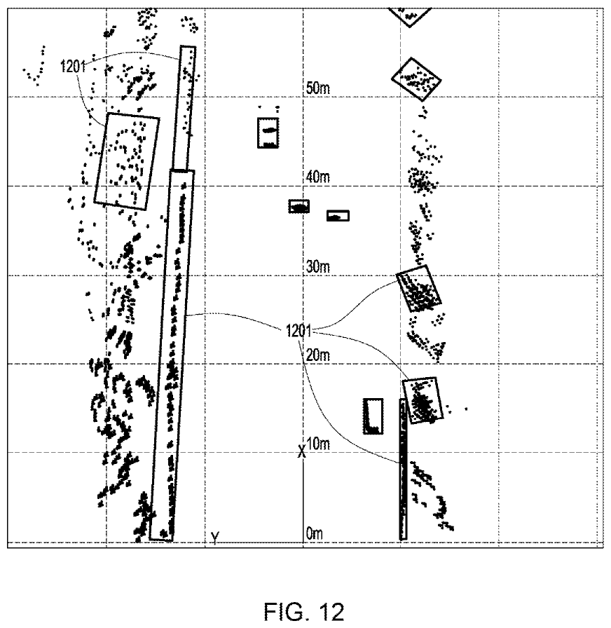

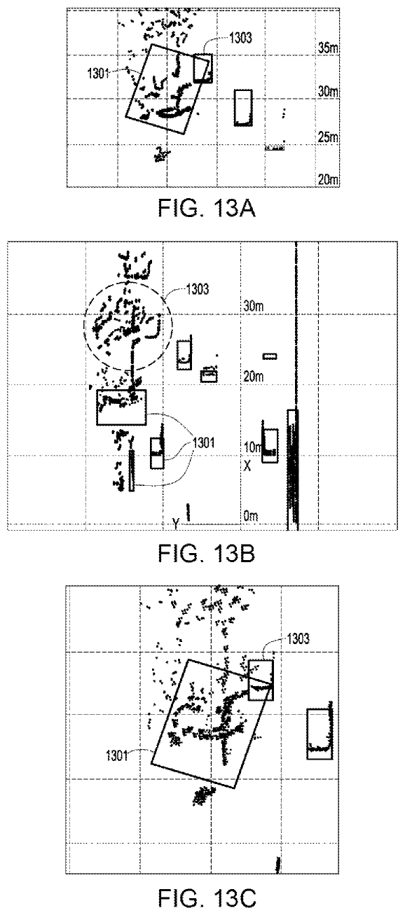

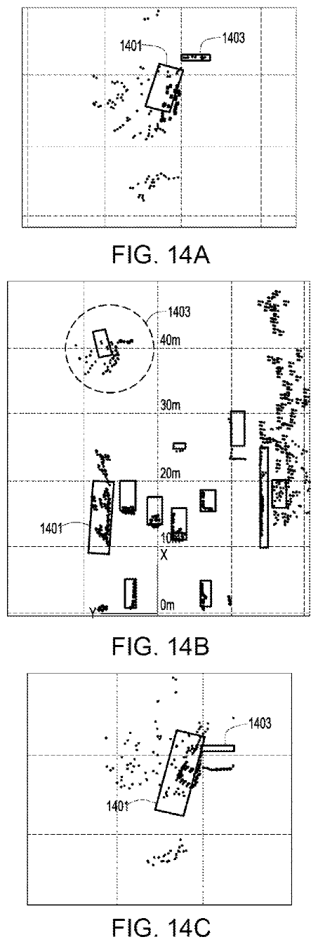

FIG. 3A and FIG. 3B are flowcharts illustrating operations of the bush detection system 100 (and/or the processor 130) according to an exemplary embodiment of the present disclosure. FIG. 4A, FIG. 4B, FIG. 4C and FIG. 4D, FIG. 5, FIG. 6, FIG. 7, FIG. 8, FIG. 9A and FIG. 9B, FIG. 10, FIG. 11A and FIG. 11B, and FIG. 12 illustrate operations of the bush detection system 100 (and/or the processor 130) according to an exemplary embodiment of the present disclosure.

Referring to FIG. 3A, in operation 301, the bush detection system 100 may obtain point data of each object.

The bush detection system 100 may identify point data of objects located within a predetermined first reference distance with respect to the vehicle 1 (also referred to as a “host vehicle”), for example, objects located within a predetermined distance in a longitudinal direction (e.g., 55 meters (m)) and/or a predetermined distance in a lateral direction (e.g., 55 m), from point data of each object.

For example, when an object located on a street including a distance from the vehicle 1 which is greater than a predetermined second reference distance (e.g., 30 m) or an object box representing the object is a candidate street tree object box representing the shape of a street tree, the bush detection system 100 may be configured to determine a predetermined reference EPW value (also referred to as an EPW threshold) as a first value (e.g., 40), or as a second value (e.g., 65) greater than the first value, otherwise.

For example, the first reference distance may be greater than the second reference distance.

In operation 303, the bush detection system 100 may be configured to determine whether there is point data including EPW values greater than or equal to the predetermined reference EPW value among the point data of each object.

The bush detection system 100 may perform operation 305 when there is point data including EPW values greater than or equal to the predetermined reference EPW value among the point data of each object, or perform again operation 301, otherwise.

In operation 305, the bush detection system 100 may be configured to determine point data including EPW values greater than or equal to the predetermined reference EPW value as feature point data corresponding to a bush feature.

When an EPW of feature point data of an object including the feature point data is greater than the predetermined reference EPW value, the bush detection system 100 may add a feature point to a feature point array of the object including the feature point data.

In operation 307, the bush detection system 100 may be configured to determine a candidate bush object from among objects including the feature point data corresponding to the bush feature.

Referring to FIG. 4A, FIG. 4B, FIG. 4C and FIG. 4D, the bush detection system 100 may obtain object information including point data of each object as shown in FIG. 4A.

The bush detection system 100 may also identify an object included in a region of interest (ROI) from among objects. For example, the bush detection system 100 may identify, as the object included in the ROI, an object of point data located within a predetermined distance from the vehicle 1, for example, within a predetermined distance in a longitudinal direction and/or a predetermined distance in a lateral direction.

The bush detection system 100 may also identify an object including a size smaller than a predetermined size, from which a distribution of point data is difficult to determine, and may exclude it from a target object in bush determination.

The bush detection system 100 may also identify point data including EPW values greater than or equal to a predetermined EPW values (e.g., 50) as shown in FIG. 4B.

Furthermore, when a distribution range of point data 43 including EPW values greater than or equal to a predetermined EPW values among point cloud data 41 of objects is small, as shown in FIG. 4C, a corresponding object may be determined as an object (e.g., a vehicle) and not as a candidate bush object.

Furthermore, when a distribution range of point data 47 including EPW values greater than or equal to a predetermined EPW values among point cloud data 45 of objects is large, as shown in FIG. 4D, a corresponding object may be determined as a candidate bush object.

Additionally, to determine the candidate bush object, a ratio of the number of feature point data to the total number of point data of objects including the feature point data, the length of the longest side of an object box of an object including feature point data, a variance of distance values of feature points relative to a mean position of the objects including the feature point data, and/or an x-y covariance of the feature points of the objects including the feature point data may be further considered.

Accordingly, the bush detection system 100 may be configured to determine a ratio (“Rate(EPW)”) of the number of feature point data (“high EPW point num”) to the total number of point data (“Obj total point num”) of objects including feature point data, through Equation 1 below.

$$Rate ( EPW ) = \frac{high EPW point nu m}{Obj total point num} \qquad [ Equation 1 ]$$

(Rate(EPW): ratio, high EPW point num: the number of feature point data, Obj total point num: the total number of point data)

Furthermore, the bush detection system 100 may determine, as a box size, the length of the longest side of an object box of an object including feature point data, as expressed in Equation 2 below. The box size of the object box may be a value used to normalize a variance that varies depending on the size of the object box.

$$box size = max ( box length , box width ) \qquad [ Equation 2 ]$$

(box size: a box size of an object box, box length: the length of the object box, box width: the width of the object box)

Furthermore, the bush detection system 100 may be configured to determine a variance of distance values of feature point data with respect to a mean position of objects including the feature point data. The variance and the size of the object box may include a proportional relationship, and the object variance may increase in proportion to an increase in the length of the object box, which may require normalization.

The bush detection system 100 may also determine an x-y covariance (Oxy) of feature points of objects including feature point data, through Equation 3 below.

$${σ}_{xy} = \frac{{\sum }_{i = 0}^{N} ( {x}_{i} - {u}_{x} ) ( {y}_{i} - {u}_{y} )}{N} \qquad [ Equation 3 ]$$

(xᵢ: x-coordinate value of an ith feature point, yᵢ: y-coordinate value of the ith feature point, uₓ: mean value of x, u_{y}: mean value of y, N: number of feature points of an object including feature point data)

When a box size of an object box of an object including feature point data is smaller than a predetermined first reference size (e.g., 0.5), the bush detection system 100 may be configured to determine that it is difficult to determine a distribution of point data and may exclude the corresponding object from a target object of a candidate bush object.

Furthermore, when the shortest side of the object box (“short box length”) is smaller than the predetermined first reference size, the bush detection system 100 may apply an additional weight to the box size of the object box of the object including the feature point data.

The additional weight may be a value obtained by multiplying the short box length of the object box by 2.

For example, the bush detection system 100 may apply the additional weight to the box size, through Equation 4 below.

$$box size = box {size}_{Eq 2} + short box length \times 2 \qquad [ Equation 4 ]$$

(where, box size_{Eq2} corresponds to the box size in Equation 2)

In a case of an object whose distance from the vehicle 1 is farther than the predetermined first reference distance (e.g., 55 m), the bush detection system 100 may exclude the corresponding object from the target object of the candidate bush object because a gap between point data widens and the determination of bushes becomes ambiguous.

Additionally, the bush detection system 100 may be configured to determine a score (“Total score”) for determining a confidence level in the determination of a bush object, through Equation 5 below.

$$Total score = \frac{( {K}_{1} \times Rate ) \times ( {K}_{2} \times VarianceScores )}{( {K}_{3} \times Box size )} \qquad [ Equation 5 ]$$

(Kn: proportional constant in which the n is an integer, Rate: Rate (EPW) in Equation 1, Box size: box size in Equation 2, varianceScores: a value determined based on a variance and an x-y covariance of distance values of feature points with respect to a mean value of point data of objects including feature point data)

For example, by further specifying the foregoing Equation 5, Equation 6 below may be obtained.

Accordingly, the bush detection system 100 may be configured to determine a score (“total score”) for determining the confidence level in the determination of a bush object, through Equation 6 below.

$$total score = \frac{\begin{matrix}1.75 \times ( 0.2 \times Distance variance + \\ 0.8 \times ( x - y ) covariance )\end{matrix}}{box size score} \times ( high EPWpontRate \times 40 ) \times ( ispurbush weitht ) \qquad [ Equation 6 ]$$

The distance variance in Equation 6 may correspond to the distance variance in Equation 7 below.

$$Distance variance = getDistanceVariance ( feature points array , obj mean position \qquad [ Equation 7 ]$$

The distance variance in Equation 7 may be a variance value of feature points included in a feature point array, with respect to a mean position (“obj mean position”) of objects including feature point data, which may be determined by applying a typical variance equation.

The (x-y) covariance in Equation 6 may be the x-y covariance (“(x-y) covariance”) in Equation 8 below.

$$( x - y ) covariance = getCorVariance ( feature points array ) \qquad [ Equation 8 ]$$

The x-y covariance in Equation 8 may be a covariance value of feature point data included in a feature point array of an object including feature point data, which may be determined by applying a typical covariance equation.

“high EPWpointRate” in Equation 6 may correspond to “highEPWpointRate” in Equation 9 below.

$$high EPWpointRate = \frac{feature point s num}{totlal point num} \qquad [ Equation 9 ]$$

(feature points num: the number of feature point data included in a feature point array of an object including feature point data, total point num: the total number of point data of an object including feature point data)

“ispurebush weight” in Equation 6 may be determined based on the following conditions.

### Conditions

When there is one with an EPW of feature point data included in a feature point array which is greater than or equal to the predetermined reference EPW (e.g., 90), the ispurebush weight may become a first weight (e.g., 1). When there is no one with an EPW of the feature point data included in the feature point array which is greater than or equal to the predetermined reference EPW (e.g., 90), the ispurebush weight may become a second weight (e.g., 1.2).

The foregoing conditions may be determined based on a fact that manufactured objects such as signs, reflectors, and/or mirrors include point data with an EPW of 90 or greater, whereas objects such as bushes do not include point data with an EPW of 90 or greater.

In operation 309, the bush detection system 100 may store, in a buffer, information related to the candidate bush object for each frame.

The information related to the candidate bush object may include a movement amount of the vehicle 1 and bush information.

For example, the movement amount of the vehicle 1 may include a velocity (x-coordinate velocity (velocity x), y-coordinate velocity (velocity y)) and a yaw rate of the vehicle 1. The bush information may include point data of the candidate bush object.

When storing, in the buffer, the information related to the candidate bush object for each frame, the bush detection system 100 may correct an error of the movement amount of the vehicle 1 by a yaw rate of each frame. The correction of the error of the movement amount may indicate correcting a difference between the origin of a coordinate system of the velocity (an x coordinate (velocity x), y coordinate velocity (velocity y)) and the yaw rate of the vehicle 1 and the origin of a coordinate system of the sensing device 10.

The bush detection system 100 may store the bush information together with the movement amount of the vehicle 1 in the buffer provided in a form of a circular queue including a predetermined size as shown in FIG. 5 to accumulate data related to the candidate bush object for each certain frame.

For example, the bush detection system 100 may individually apply the movement amount of the vehicle 1 for each frame.

In FIG. 5, the case where the size of the circular queue is 8 is provided as an exemplary embodiment of the present disclosure, and accordingly information of up to eight frames after an operation of the bush detection system 100 may be stored in the circular queue.

The concept of a start index and an end index is applied to the circular queue, and thus data of the most recently obtained frame may be stored in the start index, and data of the oldest frame among the eight frames may be stored in the end index. Accordingly, frame data may be stored through simple index identification without separate memory arrangement calculation.

For each of the frames, a movement amount of the vehicle 1 (also referred to as a “host vehicle”) and bush information may be matched.

Accordingly, in each array of the circular queue, a frame count, a velocity (x-coordinate velocity (velocity x), y-coordinate velocity (velocity y)) and a yaw rate of the vehicle 1 matched to a corresponding frame, and bush data may be stored.

After the eight frames, the end index may be updated with data of a new frame (and data of a reference frame may be deleted), the end index may then be changed to the start index, and a new end index may then be determined.

Referring to FIG. 6, frame data may be sequentially stored from an array with an index of zero (0) to an array with an index of 7.

When initially obtaining frame data by the operations, the bush detection system 100 may be configured to determine an array with an index of 0 as the start index. The bush detection system 100 also may store, in an array with an index of 0, a frame count of 1, an x-coordinate velocity of 5 mps, a y-coordinate velocity of 0 mps, and a yaw rate of 0 dps, and bush data.

Subsequently, when obtaining frame data, the bush detection system 100 may change an array with an index of 1 to the start index and determine the array with the index of 0 as the end index. The bush detection system 100 may also store, in the array with the index of 1, a frame count of 2, an x-coordinate velocity of 7 mps, a y-coordinate velocity of Imps, a yaw rate of 0.5 dps, and bush data.

Subsequently, when obtaining frame data, the bush detection system 100 may change an array with an index of 2 to the start index and maintain the array with the index of 0 as the end index. The bush detection system 100 may also store, in the array with the index of 2, a frame count of 3, an x-coordinate velocity of 6 mps, a y-coordinate velocity of 0 mps, a yaw rate of 0 dps, and bush data.

Subsequently, each time frame data is obtained, the bush detection system 100 may sequentially change, to the start index, an array with an index of 3, an array with an index of 4, an array with an index of 5, an array with an index of 6, and an array with an index of 7. The bush detection system 100 may also store data of sequentially obtained frames for each index array.

At the acquisition of frame data after storing data of a frame up to the array with the index of 7, the bush detection system 100 may change the array with the index of 0 to the start index, and delete previously stored data and store data of a newly obtained frame. The bush detection system 100 may also change the array with the index of 1 to the end index.

In operation 311, the bush detection system 100 may convert point data of a frame of a previous time step into point data of a frame of a current time step, based on a vehicle movement amount compensation for each frame.

The bush detection system 100 may be configured to determine and store a compensation amount for each index of the circular queue.

When data of a new frame matches the start index and is stored, the bush detection system 100 may add and sum the data of the new frame to all past data in the circular queue. Such an operation may be performed because a movement amount to be compensated for each data stored in each array of the circular queue is different for each frame.

As shown in FIG. 7, when frame data is stored in each of three arrays of a circular queue including an end index of 0 and a start index of 2, a compensation amount of each index may be a result of summing values for each item of the three indices.

For example, a frame count of index 0 may be stored as 1. Also, a compensation amount for an x-coordinate velocity (velocity x) of index 0 may be determined and stored as a result value of 18 mps obtained by adding 5 mps, 7 mps, and 6 mps, which are x-coordinate velocities (velocities x) of indices 0 to 2. Also, a compensation amount for a y-coordinate velocity (velocity y) of index 0 may be determined and stored as a result value of Imps obtained by adding 0 mps, Imps, and 0 mps, which are y-coordinate velocities (velocities y) of indices 0 to 2. Also, a compensation amount for a yaw rate of index 0 may be determined and stored as 0.5 dps, which is a result value obtained by adding 0 dps, 0.5 dps, and 0 dps, which are yaw rates of indices 0 to 2. Also, in index 0, 0 to 2 data (0˜2 data), which is VDISP data of indices of 0) to 2, may be stored.

Furthermore, a frame count of index 1 may be stored as 2. Also, a compensation amount for an x-coordinate velocity (velocity x) of index 1 may be determined and stored as a result value of 13 mps obtained by adding 7 mps and 6 mps, which are x-coordinate velocities (velocity x) of indices 1 and 2. Also, a compensation amount for a y-coordinate velocity (velocity y) of index 1 may be determined and stored as a result value of Imps obtained by adding Imps and 0 mps, which are y-coordinate velocities (velocities y) of indices 1 and 2. Also, a compensation amount for a yaw rate of index 1 may be determined and stored as 0.5 dps, which is a result value obtained by adding 0.5 dps and 0 dps, which are yaw rates of indices 1 and 2. Also, in index 1, 1 to 2 data (1˜2 data), which is VDISP data of indices 1 and 2, may be stored.

Furthermore, a frame count of index 2 may be stored as 3. Also, a compensation amount for an x-coordinate velocity (velocity x) of index 2 may be determined and stored as 6 mps, which is the x-coordinate velocity (velocity x) of index 2. Also, a compensation amount for a y-coordinate velocity (velocity y) of index 2 may be determined and stored as 0 mps, which is the y-coordinate velocity (velocity y) of index 2. Also, a compensation amount for a yaw rate of index 2 may be determined and stored as 0 dps, which is a result value obtained by adding 0 dps which is the yaw rate of index 2. Also, in index 2, 2 data, which is VDISP data of index 2 may be stored.

As shown in FIG. 7, when frame data is stored in each of the eight arrays of the circular queue including the end index of 0 and the start index of 7, a compensation amount for each index may be a result of summing values for each item of the eight indices.

Referring to FIG. 7, a frame count of index 7 may be stored as 8. Also, compensation amounts for an x-coordinate velocity (velocity x), a y-coordinate velocity (velocity y), and a yaw rate of index 7 may be determined and stored as 9 mps, 0 mps, and 0 dps, respectively. Also, in index 7, VDISP data (7 data) of index 7 may be stored.

In such a way, when a time interval (dt) for each frame is 0.1 second (sec), a compensation amount for a movement of the vehicle 1 based on a compensation amount for each item of index 7, which is the start index, may be determined as 5.8 m in an x-axis direction (dx), 0.3 m in a y-axis direction (dy), and an angle (dtheta) of 0.15 deg.

For example, when detecting bushes 81 and 83 in a frame (e.g., t-1 frame) obtained at a time step t-1 as shown in FIG. 8, the bush detection system 100 may be configured to predict bushes in a frame (e.g., t frame) at a time step t, based on a velocity (e.g., own velocity x, own velocity y) of the vehicle 1 and a sensor time interval.

In the present example, when the velocity x of the vehicle 1 at the time step t-1 is 10 mps, the velocity y is 0 mps, and the sensor time interval is 0.1 sec, as shown in FIG. 8, it may be predicted that the bushes 81 and 83 detected at the time step t-1 are present at a position separated by 1 m on an X-axis (and by Om on a Y-axis) at the time step t.

For example, referring to FIG. 9A and FIG. 9B, the bush detection system 100 may obtain a frame including data 91 of candidate bush objects on right and left sides in front of the vehicle 1 as shown in FIG. 9A.

By the foregoing operations, the bush detection system 100 may be configured to determine a compensation amount for a movement of the vehicle 1 and compensate for a position of the data 91 of the candidate bush objects of FIG. 9A, as shown in FIG. 9B.

Referring to FIG. 9B, a result may be output by compensating for the position of the data 91 of the candidate bush objects after eight frames are obtained.

For example, based on that an acquisition time used to obtain up to the eighth frame is 0.8 sec, and it is determined that a compensation amount for a movement of the vehicle 1 is 14.1 m in the x-axis direction (dx), 0.0 m in the y-axis direction (dy), and an angle (dtheta) of 0 deg, a result obtained by compensating for the position of the data 91 of the candidate bush objects may be output, as shown in FIG. 9B.

In operation 313, the bush detection system 100 may be configured to generate a grid map (also referred to as a “bush grid map”) based on the converted point data of the frame of the current time step.

As shown in FIG. 10, the bush detection system 100 may be configured to generate and output a bush grid map including minimum height information of bushes.

To the present end, the bush detection system 100 may identify (or extract) point data of a candidate bush object of a current frame.

The bush detection system 100 may also convert point data (x, y, z coordinate values) of a candidate bush object of a current frame into a grid index (row, col, height).

The bush detection system 100 may also assign a bush grid flag of point data to a corresponding grid cell and store the height.

For example, in a case where a cell including a bush grid flag of 1 is a target to which a bush grid flag is to be assigned by another point, when the height of the other point is smaller than a previously stored height, the bush detection system 100 may update the height so that only the height of the other point is applied. Accordingly, the bush detection system 100 may store the minimum height of points in each cell.

The bush detection system 100 may remove the number of redundant execution cases for point data to minimize a bush grid operation or computation.

The bush detection system 100 may be configured to generate the bush grid map including the same size and resolution as those of a grid map generated for determining a moving and/or stationary object. Accordingly, a convolution operation with the generated grid map may be performed to determine a moving and/or stationary object.

Referring back to FIG. 3B, in operation 315, the bush detection system 100 may assign a drivable flag to the bush grid map.

The drivable flag may be provided to determine whether an object is able to pass under bushes based on the bush grid map.

Referring to FIG. 11A, the bush detection system 100 may extract a path 1101 along which the vehicle 1 may move based on the bush grid map.

For example, the path 1101 may be determined based on positions of bushes.

When there are two bushes on both sides as shown in FIG. 11A, the bush detection system 100 may be configured to determine a middle portion of the two bushes as the path 1101, and when there is one bush afterward, the bush detection system 100 may determine, as the path 1101, a portion including the same distance value with one bush as a distance value between the middle portion and the two bushes.

The bush detection system 100 may also convert the path 1101 of the vehicle 1 into a point array to be the same as an x-axis resolution of the bush grid map based on an equation representing the path 1101 of the vehicle 1.

The bush detection system 100 may also identify cells to which points are matched the closest on the left and right sides of the bush grid map, based on a y coordinate value of each point data of the path 1101 converted into the point array.

Furthermore, the height is stored in a cell to which point data of the bush grid map is matched, and the bush detection system 100 may assign a drivable flag of 1 when the height is greater than or equal to a predetermined reference height (e.g., 2.5 m) to represent an area 1103 to which the drivable flag of 1 is assigned in the bush grid map as a drivable area which is available to drive as shown in FIG. 11B.

FIG. 11B shows a drivable bush area 1103 on a right side from the vehicle 1, and of FIG. 11B shows point cloud data of street trees (e.g., point cloud data of street trees on a YZ plane), on a right side under which the vehicle 1 is able to travel.

Furthermore, when the height is less than the predetermined reference height, the bush detection system 100 may assign a non-drivable flag of 0 to represent a non-drivable area which is not available to drive.

In operation 317, the bush detection system 100 may identify an OOI determined for object tracking.

In operation 319, the bush detection system 100 may be configured to determine whether point data of the OOI is in the same cell as the point data of the grid map.

To the present end, the bush detection system 100 may convert each point data included in box data representing the OOI into an index of the grid map.

Based on the index of the grid map obtained through the conversion, the bush detection system 100 may be configured to determine whether the point data included in the box data representing the OOI is located in the same cell as the point data of the bush grid map.

The bush detection system 100 may perform operation 321 when the point data of the OOI is in the same cell as the point data of the grid map, and end the operations otherwise.

In operation 321, the bush detection system 100 may be configured to determine whether the OOI is not an object in the drivable area.

Based on the index of the grid map and whether the drivable flag assigned to the grid map is the drivable flag of 1 or the drivable flag of 0, the bush detection system 100 may be configured to determine whether the point data of the OOI is point data of the drivable area and finally determine whether the OOI is an object in the drivable area.

In operation 323, after determining whether the OOI is an object in the drivable area or not an object in the drivable area, the bush detection system 100 may output class information of the OOI and a confidence level of the class information.

For example, the class information may be information indicating that the OOI is bushes or information indicating that the OOI is an object other than bushes.

The bush detection system 100 may identify the bush flag and/or the drivable flag of a cell of the bush grid map that matches the converted index.

When there is no bush flag of 1 in the cell of the bush grid map that matches the converted index, the bush detection system 100 may be configured to determine the OOI not to be bushes and output information indicating that the OOI is not bushes.

When the bush flag of 1 is in a cell of the bush grid map matching the converted index, and all the drivable flags in the cells of the bush grid map matching the converted index indicate 1, the bush detection system 100 may be configured to determine the point data of the OOI not to be bushes but an object passing under the bush, and output information indicating that the OOI is not bushes.

When the bush flag of 1 is in a cell of the bush grid map matching the converted index, and even one of the drivable flags in the cells of the bush grid map matching the converted index indicates 0, the bush detection system 100 may be configured to determine the OOI to be bushes and output information indicating that the OOI is bushes.

On an object with the bush flag of 1, an association for tracking may not be performed. Accordingly, it is possible to reduce an amount of computation and reduce an error in the association, in an association step for object tracking.

By the operations described above, the bush detection system 100 may output objects located in front of the vehicle 1 as data representing bushes 1201 and an object which is not bushes, as shown in FIG. 12.

When it is determined that the OOI is not bushes by the operations described above, the bush detection system 100 may be configured to determine and output the confidence level as a level of 0.

For example, when it is determined that the OOI is a top end of a special vehicle, the bush detection system 100 may be configured to determine and output the confidence level as a level of 1.

Furthermore, when a score (total score) for determining a candidate bush object in Equation 6 is between 3 and 4.5, the bush detection system 100 may be configured to determine and output the confidence level as a level of 2.

Furthermore, when the score (total score) for determining a candidate bush object in Equation 6 is greater than 4.5, the bush detection system 100 may be configured to determine and output the confidence level as a level of 3.

In operation 325, the bush detection system 100 may store, in a buffer, information related to the OOI determined as bushes as information related to the candidate bush object.

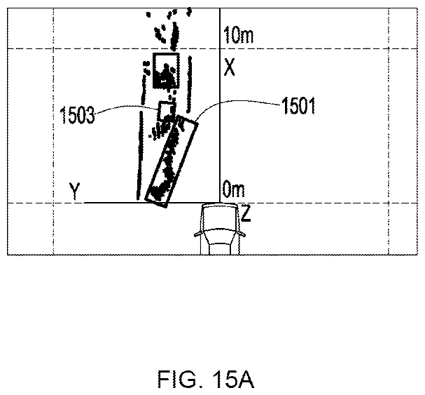

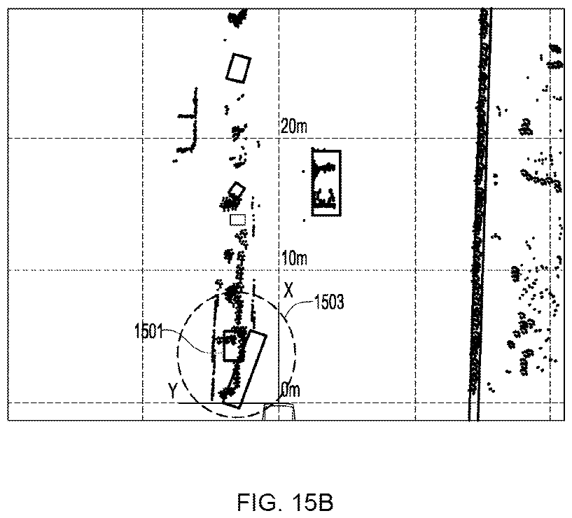

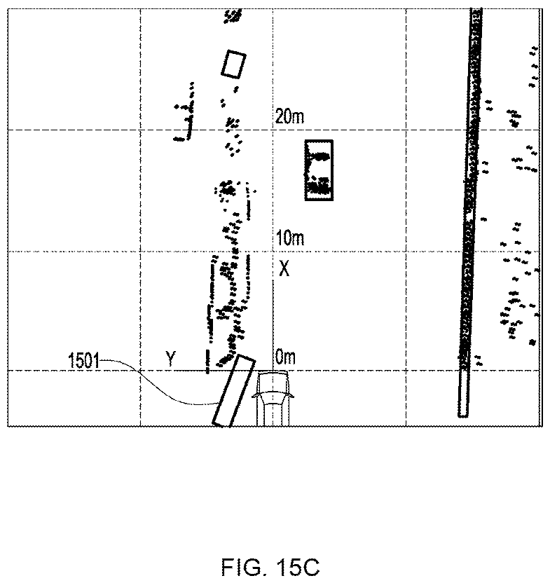

FIG. 13A, FIG. 13B and FIG. 13C, FIG. 14A, FIG. 14B and FIG. 14C and FIGS. 15A-15C illustrate the effects of embodiments of the present disclosure by comparing object information obtained according to the related art and the exemplary embodiments of the present disclosure.

Referring to FIG. 13A, FIG. 13B and FIG. 13C, when there is a top end portion of street trees invading a car-only road and a vehicle located in front of the vehicle 1 is driving under the street trees, it is necessary to determine the top end portion of the street trees as bushes, and separate it from a target object for the association for tracking and determine it as a stationary object.

For example, when there is a top end portion of street trees invading a car-only road and a vehicle located in front of the vehicle 1 is driving under the street trees, an object box 1301 representing the street trees and an object box 1303 representing a partially overlapping vehicle may need to be generated as accurate output data, as shown in FIG. 13A.

However, according to the related art, there has been a problem in that the object box 1301 representing the street trees and the object box 1303 representing the vehicle located in front of the vehicle 1 are generated incorrectly, as shown in FIG. 13B.

In contrast, according to the exemplary embodiments described herein, it may be verified that the object box 1301 representing the street trees and the object box 1303 representing the vehicle located in front of the vehicle 1 are generated correctly, as shown in FIG. 13C.

Accordingly, compared to the related art, it may be verified that the top end portion of the street trees is stationary, and the vehicle is moving, through the separation of the top end portion of the street trees and the vehicle passing under the street trees.

Referring to FIG. 14A, FIG. 14B and FIG. 14C, when there is a top end portion of street trees invading a car-only road and a vehicle located in front of the vehicle 1 passes under the street trees to drive, determining the top end portion of the street trees as bushes and separating it from the vehicle located in front of the vehicle 1 may improve the accuracy in tracking the vehicle located in front of the vehicle 1.

For example, when there is a top end portion of street trees invading a car-only road and a vehicle located in front of the vehicle 1 passes under the street trees to drive, accurate output data may need to be obtained by generating an object box 1401 representing the street trees and an object box 1403 representing the separated vehicle, as shown in FIG. 14A.

However, according to the related art, there has been a problem in that the object box 1401 representing the street trees and the object box 1403 representing the vehicle located in front of the vehicle 1 are generated incorrectly, as shown in FIG. 14B.

In contrast, according to the exemplary embodiments described herein, it may be verified that the object box 1401 representing the street trees and the object box 1403 representing the vehicle located in front of the vehicle 1 are accurately separated and generated, as shown in FIG. 14C.

Referring to FIGS. 15A-15C, when there is a flower bed next to the vehicle 1 (also referred to as a “host vehicle”) on a general road, it is necessary to determine the flower bed as bushes to improve the accuracy of driving control for the vehicle 1. For example, when the vehicle 1 erroneously determines the flower bed as a cut-in vehicle, there may be some situations such as emergency braking of the vehicle 1.

For example, when there are a flower bed and a vehicle around the flower bed next to the vehicle 1 (also referred to as a “host vehicle”) on a general road, accurate output data may need to be generated as an object box 1501 representing the flower bed and an object box 1503 representing the vehicle around the flower bed are separated, as shown in FIG. 15A.

However, according to the related art, there has been a problem in that the object box 1501 representing the flower bed and the object box 1503 representing the vehicle are generated incorrectly, as shown in FIG. 15B.

In contrast, according to the exemplary embodiments described herein, the object box 1501 representing the flower bed may be generated accurately, as shown in FIG. 15C, and accordingly the vehicle 1 may accurately determine the flower bed as a stationary object.

The present disclosure described above may be embodied as computer-readable code on a medium in which a program is recorded. The computer-readable medium includes all types of recording devices in which data readable by a computer system is stored.

Examples of the computer-readable medium include a Hard Disk Drive (HDD), a solid-state drive (SSD), a silicon disk drive (SDD), a read-only memory (ROM), a random-access memory (RAM), a CD-ROM, a magnetic tape, a floppy disk, an optical data storage device, and the like.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A bush detection method, comprising:
based on echo pulse width (EPW) values of point data of each object, determining by a processor, as a candidate bush object, an object including feature point data corresponding to a bush feature;
generating, by the processor, a grid map based on point data of the candidate bush object; and
based on point data, among point data of an object of interest (OOI) determined for an association, that matches a cell encompassing point data of the grid map, determining, by the processor, the OOI as bushes and outputting related information.

2. The bush detection method of claim 1, wherein the determining the object including the feature point data as the candidate bush object includes:
determining, as the feature point data, point data including EPW values greater than or equal to a predetermined reference EPW value among the point data of each object, and storing the feature point data in a feature point array of a corresponding object.

3. The bush detection method of claim 1, wherein the point data of each object is located within a predetermined distance from a vehicle.

4. The bush detection method of claim 1, wherein the determining the object including the feature point data as the candidate bush object is performed based on at least one of:
a ratio of a number of the feature point data to a total number of point data of the object including the feature point data, a length of a longest side of an object box of the object including the feature point data, a variance of each of the feature point data with respect to a mean position of the object including the feature point data, or a covariance of feature points of objects including the feature point data.

5. The bush detection method of claim 1, further including:
converting candidate bush point data of a previous time step frame of the candidate bush object into candidate bush point data based on a current time step frame by compensating for a movement amount for each frame based on a movement amount of a vehicle at acquisition of each frame of the candidate bush object,
wherein the point data of the candidate bush object includes the converted candidate bush point data obtained by the converting.

6. The bush detection method of claim 5, further including:
storing, in a buffer including a predetermined size, the candidate bush point data for each frame and movement amount information of the vehicle at acquisition of a corresponding frame.

7. The bush detection method of claim 5, wherein the generating the grid map includes:
based on converting the converted candidate bush point data into an index of the grid map, assigning a bush grid flag and matching height information comprised in a corresponding index, to a cell of the grid map matching the converted candidate bush point data.

8. The bush detection method of claim 7, wherein, when two or more point data of the converted candidate bush point data match one cell of the grid map, the height information stored in the one cell is information of a minimum height in height information of the two or more point data.

9. The bush detection method of claim 8, further including:
determining a movable path of the vehicle on the grid map;
identifying cells to which the bush grid flag is assigned, which are closest on left and right sides with respect to Y-axis coordinate values corresponding to the movable path, in the grid map;
assigning a drivable flag to cells including height information greater than or equal to a predetermined reference height among the identified cells; and
assigning a non-drivable flag to cells including height information lower than the predetermined reference height among the identified cells.

10. The bush detection method of claim 9, wherein the determining the OOI as the bushes includes:
when at least one of the point data of the OOI matches a cell of the grid map to which the bush grid flag is assigned, and at least one of the point data of the OOI matches a cell of the grid map to which the drivable flag is assigned, determining the OOI as the bushes.

11. The bush detection method of claim 10, further including:
determining a score based on a ratio of a number of feature point data to a total number of point data of the object including the feature point data, a variance of each of the feature point data with respect to a mean position of the object including the feature point data, a covariance of feature points of the object including the feature point data, and the EPW values of the feature point data; and
assigning a confidence level to the OOI determined as the bushes, based on the determined score.

12. The bush detection method of claim 1, wherein the OOI determined as bushes is excluded from an OOI for the association.

13. A bush detection system, comprising:
an interface configured to receive, from a Light Detection and Ranging (LiDAR), point data of each object and echo pulse width (EPW) values of the point data of each object; and
a processor communicatively or electrically connected to the interface,
wherein the processor is configured to:
based on the EPW values of the point data of each object, determine an object including feature point data corresponding to a bush feature as a candidate bush object;
generate a grid map based on point data of the candidate bush object; and
based on point data, among point data of an object of interest (OOI) determined for an association, that matches a cell encompassing point data of the grid map, determine the OOI as bushes and output related information.

14. The bush detection system of claim 13, wherein the processor is further configured to:
determine, as the feature point data, point data including EPW values greater than or equal to a predetermined reference EPW value of the point data of each object, and store the feature point data in a feature point array of a corresponding object.

15. The bush detection system of claim 13, wherein the processor is further configured to:
determine the object including the feature point data as the candidate bush object, based on at least one of a ratio of a number of feature point data to a total number of point data of the object including the feature point data, a length of a longest side of an object box of the object including the feature point data, a variance of each of the feature point data with respect to a mean position of the object including the feature point data, or a covariance of feature points of the object including the feature point data.

16. The bush detection system of claim 13, wherein the processor is further configured to:
convert candidate bush point data of a previous time step frame of the candidate bush object into candidate bush point data based on a current time step frame by compensating for a movement amount for each frame based on a movement amount of a vehicle at acquisition of each frame of the candidate bush object,
wherein the point data of the candidate bush object includes the converted candidate bush point data obtained by the converting.

17. The bush detection system of claim 16, wherein the processor is configured to:
based on converting the converted candidate bush point data into an index of the grid map, assign a bush grid flag and match height information comprised in a corresponding index, to a cell of the grid map matching the converted candidate bush point data.

18. The bush detection system of claim 17, wherein, when two or more point data of the converted candidate bush point data match one cell of the grid map, the height information stored in the one cell is information of a minimum height in height information of the two or more point data.

19. The bush detection system of claim 18, wherein the processor is further configured to:
determine a movable path of the vehicle on the grid map;
identify cells to which the bush grid flag is assigned, which are closest on left and right sides with respect to Y-axis coordinate values corresponding to the movable path, in the grid map;
assign a drivable flag to cells including height information greater than or equal to a predetermined reference height among the identified cells; and
assign a non-drivable flag to cells including height information lower than the predetermined reference height among the identified cells.

20. The bush detection system of claim 19, wherein the processor is further configured to:
when at least one of the point data of the OOI matches a cell of the grid map to which the bush grid flag is assigned, and at least one of the point data of the OOI matches a cell of the grid map to which the drivable flag is assigned, determine the OOI as the bushes.
